(19) United States
(12) Patent Application Publication
(10) Pub. No.: US 2005/0015279 A1
(43) Pub. Date: Jan. 20, 2005

(54) Service order system and user interface for use in healthcare and other fields

(76) Inventor: Donald W. Rucker, Philadelphia, PA (US)

Correspondence Address: Alexander J. Burke, Intellectual Property Department 5th Floor, 170 Wood Avenue South, Iselin, NJ, 08830, US

(21) Appl. No.: 10/704,400

(22) Filed: Nov. 7, 2003

Related U.S. Application Data
(60) Provisional application No. 60/472,283, filed on May 21, 2003.

(51) Int. Cl. G06F 17/60

(52) U.S. Cl. 705/2

(57) ABSTRACT

A system provides a user interface display allowing clinicians to perform computerized treatment order entry by concurrently applying multiple strategies for placing computerized orders for a specific patient. A system provides a displayable list of services available for order by a healthcare provider in providing health care to a patient. The system includes a display processor for initiating generation of data representing a hierarchical sequence of display images. The display images include a first menu of display items enabling a user to select an initial set of services for order from predetermined candidate sets of services, in response to first criteria. The display images also include a second menu of display items enabling a user to select a service to add to the initial order set from a set of orderable services associated with a healthcare provider organization department, to produce a combined order set. An order processor initiates ordering of the orders in the combined order set in response to user command.

This is a non-provisional application of provisional application Ser. No. 60/472,283 by D. Rucker filed May 21, 2003.

### FIELD OF THE INVENTION

This invention concerns a system and user interface supporting user ordering of services associated with hospital departments for treatment of a patient.

### BACKGROUND OF THE INVENTION

Computerized placement of orders by physicians for patient treatment is used in a relatively small proportion of US hospital stays despite the existence of a substantial body of scientific literature showing clear improvements in patient safety derived when using such a system. Little use is made of this life-saving technology because physicians view computerized order entry as too slow and cumbersome. Known physician order entry systems employ separate navigation hierarchies for each ordering method. Further, such known systems typically employ one set of display menus to search for sets of orderable treatments and a different set of display menus to search for individual orders. In addition, when a desired order involves a mix of both a set of predetermined orders and an individual order for treatment, known systems typically require the user to perform a cumbersome two-pass process to initiate the order. This involves a user in repeating ordering and analysis steps in both selecting an order set from multiple predetermined candidate sets and in selecting an individual order. Existing systems do not support concurrently editing an order set whilst providing access to other ordering menus that would eliminate the cumbersome two-pass process. Consequently, a physician is faced with the onerous and error prone task of remembering previously entered parameters associated with selecting an order set for recall in subsequently selecting an additional compatible individual treatment order.

Known systems typically do not allow combining of order sets, either in whole or in part, and do not support a sequenced departmentally-based admitting and treatment ordering strategy. Existing systems require a physician to either accept a predetermined order set as a whole, even if particular orders of the set are not applicable for a patient, or to use a slower separate departmentally-based admitting and ordering process. Further, known systems fail to provide user friendly access to support selection of an individual treatment order at flexible points of a workflow task sequence involved in providing healthcare to a patient. A physician seeking to access an individual order, for example, is typically constrained to use time-consuming and clumsy text string search and string completion tools to find a desired individual orderable item. A system according to invention principles addresses the previously identified deficiencies and associated problems.

### SUMMARY OF INVENTION

A system allows a physician to seamlessly navigate between user interface menus to select a treatment order set from predetermined order sets including standard sequence departmentally-based hospital admission order sets and individual physician treatment orders. A system provides a displayable list of services available for order by a healthcare provider in providing health care to a patient. The system includes a display processor for initiating generation of data representing a hierarchical sequence of display images. The display images include a first menu of display items enabling a user to select an initial set of services for order from predetermined candidate sets of services, in response to first criteria (e.g. admission, preoperative, disease-based or treatment-based order sets). The display images also include a second menu of display items enabling a user to select a service to add to the initial order set from a set of orderable services associated with a healthcare provider organization department, to produce a combined order set (e.g. additional nursing, laboratory, radiology or medication orders). An order processor initiates ordering of the orders in the combined order set in response to user command.

### BRIEF DESCRIPTION OF THE DRAWING

FIG. 1 shows one embodiment of a system and user interface for processing and managing treatment order information, according to invention principles.

FIG. 2 shows a user interface display image menu supporting user selection of an initial treatment order set for customization, according to invention principles.

FIG. 3 shows a user interface display image menu supporting user selection of hospital department associated orders in addition to an initial treatment order set, according to invention principles.

FIGS. 4-8 show user interface display image menus in a user menu navigation sequence (including images of FIGS. 2 and 3) illustrating user ordering of treatments for a particular patient, according to invention principles.

### DETAILED DESCRIPTION OF INVENTION

A diagnosis and treatment order processing system employs a user interface that manages display and selection of multiple forms of computerized physician orders and order sets. In particular, it allows a physician to seamlessly navigate between displayed menus enabling a user to compose and initiate an order comprising a selected predetermined order set containing multiple orders such as a standard sequence departmentally-based hospital admission order set or another order set (e.g., for medications or laboratory tests or radiological studies) as well as individual treatment orders. The system advantageously integrates multiple clinical ordering strategies that are used by clinicians, or are used under the direction of clinicians, into a sequence of user navigable hierarchical display images. A composite user interface display image concurrently displays multiple windows individually presenting multiple ordering strategies. One strategy advantageously employs a departmental order structure that categorizes orders for display by association with a hospital department or function and is integrated into a desirable ordering sequence.

As used herein an order set comprises one or more individual orders and an order comprises a record indicating (or data representing) a treatment, medication, service or other resource that is orderable by a physician for use in treating or delivering healthcare to a patient or to support or facilitate delivering healthcare to a patient. Further, a service comprises, services performed by a healthcare worker for a patient, goods to be used in providing a service to a patient, medication to be administered to a patient, treatment to be provided to a patient or therapy to be provided to a patient. The system also provides a user interface automating departmentally based ordering and enables a user rapid (substantially immediate) access to both order sets and individual orders during an ordering process or order review. The system also supports providing a user with decision support information such as rules, alerts or reminders (e.g., identifying a clinical alert or potential drug interaction condition associated with a treatment) concurrently during an order process and before a treatment is selected for inclusion in an order for a specific patient. For this purpose the system uses context information of a proposed treatment comprising other treatment orders, order sets or a departmentally-based order associated with an admission order strategy. The decision-support logic can be either internal or external to the underlying system.

The user interface system enables a user to select individual treatments and treatment order sets using a departmentally-based hospital admission ordering strategy. The department sequence is known by physicians through an acronym, typically “ADCVANDIML” or “ADCVANDISSL” where each of the sequence of letters in the acronym stand for either a department of the hospital or a core order to be acted upon by a specific department of the hospital. Thus for “ADCVANDIML”, the acronym is comprised of “admission, diagnosis, condition, vital signs, allergies, diet, inputs/outputs, medications, and labs”. The user interface system automatically navigates a user to a “next” department in the departmentally associated sequence in response to acceptance or selection of a current department associated order. The system also advantageously supports user selection of a mixture of departmentally associated order sets and individual orders without being required to specifically navigate through a separate user interface navigation hierarchy. The user interface system monitors and stores commonly ordered treatment order sets and individual orders for use as predetermined orders for selection by a user. In addition, the system employs a search function that is accessible from ordering image windows for searching for individual orders without requiring a user to navigate multiple menus to reach the search menu. System menus provide a user with concurrently available options for navigating through departmentally associated treatment order sets as well as individual treatment order menus to select desired orders set in a single user operation session without requiring a user to initiate multiple executable applications and associated navigate functions.

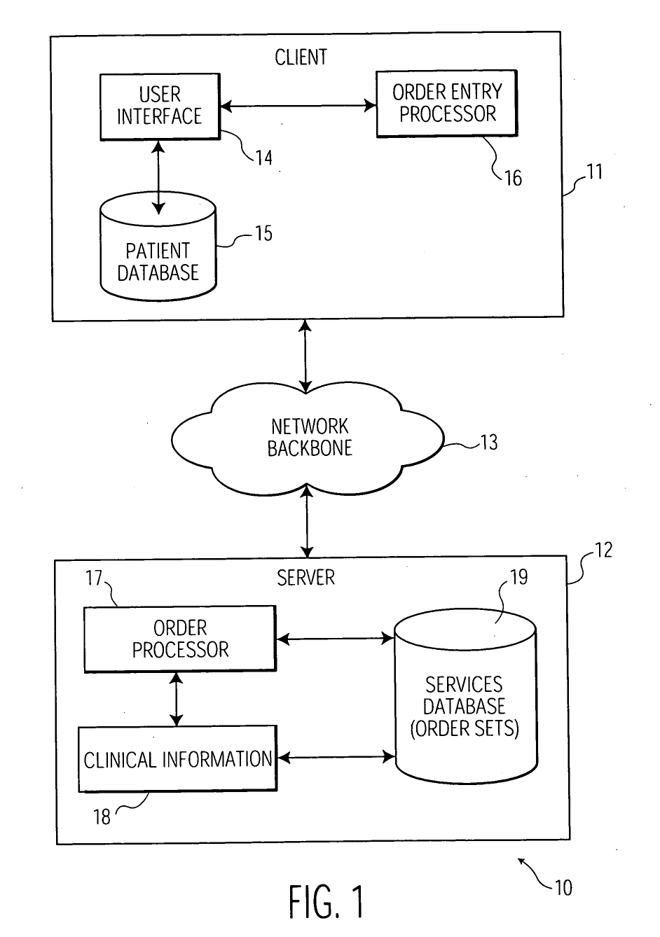

FIG. 1 shows one embodiment of a system and user interface for processing and managing treatment order information. The user interface employs order sets categorized by type and individual orderable services (such as nursing orders, diet, labs, x-rays and medication treatment orders) categorized by hospital department. The classification of an individual order by hospital department facilitates sorting and aggregation of orders in support of user selection of treatment orders for a particular patient. A system 10 includes an executable user interface client application 11 comprising a physician order entry application for ordering clinical services (e.g., lab tests, medications, radiology procedures, diagnostic test or therapeutic procedures, etc.). A server 12, which is accessible by client 11 over a network 13, includes an executable application (order processor 17) for generating a list of orderable clinical services for a given patient preferably based on patient medical information provided by a user via user interface application 11. Application 11 and order processor 17 in other embodiments (and any other functions of server 12) may be incorporated as a single application (or multiple) applications and located in any processing device on a hierarchical communication network It is to be understood that although a client-server framework is depicted FIG. 1, the system 10 may be implemented using any suitable computing environment framework such as P2P (peer-to-peer) or master/slave, for example. The network 13 may comprise any suitable network configuration such as an Intranet, a LAN (local area network), WAN (wide area network), P2P, a global computer network (e.g., Internet), a wireless communications network, or any combination thereof. Those of ordinary skill in the art can readily envision various architectures for implementing a system for ordering clinical services based on the teachings herein and nothing herein shall be construed as a limitation of the scope of the invention.

User interface application 11, which operates on, e.g., a user workstation, comprises a user interface module 14 for rendering, e.g., a GUI (graphical user interface) (or any other suitable interface such as a speech interface or combination speech/GUI interface or an Internet browser) and an order entry processor 16 for generating application-specific entry forms/menus and interactive windows that are rendered by the user interface 14 and for processing orders selected by the user. A local database 15 comprises a repository of patient data of one or more patients. The patient data comprises medical information associated with one or more patients, which may be used by the user for ordering medical services. Server 12 bidirectionally communicates with user interface application 11 via network 13 in responding to commands received from a user workstation and processed by application 11. Server 12 comprises an order processor 17, a clinical information database 18 and a database 19 of sets of orderable services as well as individual service orders. Database 19 includes sets of orderable services organized by healthcare provider organization department and particular function (e.g., per the ADCVANDIML categories as previously discussed).

System 10 enables a user to compose and initiate orders for treatment of a patient by concurrently using individual or multiple different ordering strategies. These strategies include, a sequential departmentally-based hospital admission ordering strategy, a non-sequential individual or department associated ordering strategy and an individual treatment order selection strategy (e.g., based on database order search and selection). Also included are any order sets designed based on diseases, procedures or therapies. Order set selection may be conditioned on knowledge of the user. For example, when a cardiologist is identified as the user, order sets of interest to a cardiologist may be preferentially displayed. Clinical information database 18 maintains relationship information linking various clinical conditions and predetermined treatment order sets and individual treatment orders stored in database 19. The system is designed with the assumption that there are multiple strategies for generating the initial order set(s) including based on institutional policy, physician preference, physician specialty, evidence-based medicinal characteristics, statistical association, computational inference, or prior clinical diagnoses.

System 10 operates in conjunction with, or as part of, a hospital information system (not shown) linked via network 13. The hospital information system may also maintain records of order sets and individual orders and may transmit orders to appropriate destinations such as database 19. The hospital information system includes a clinical information system supporting patient specific tasks related to treatment order entry and processing. Order processor 17 employs decision support functions based on rules, alerts, reminders, and also employs database 19 including commonly ordered sets of treatments, individual treatment orders and user customized lists of favored order choices. Application 11 in conjunction with order processor 17 initiates generation of user interface images supporting user treatment order selection and management as well as scheduling of associated workflow tasks for performance by healthcare workers. The user interface images enable a user to view a patient-specific treatment order as well as other current or pending orders and allows a user to view orders designated for signature (or other authorization) to initiate order processing. The user interface images also support search and sorting of orders by date or by other criteria.

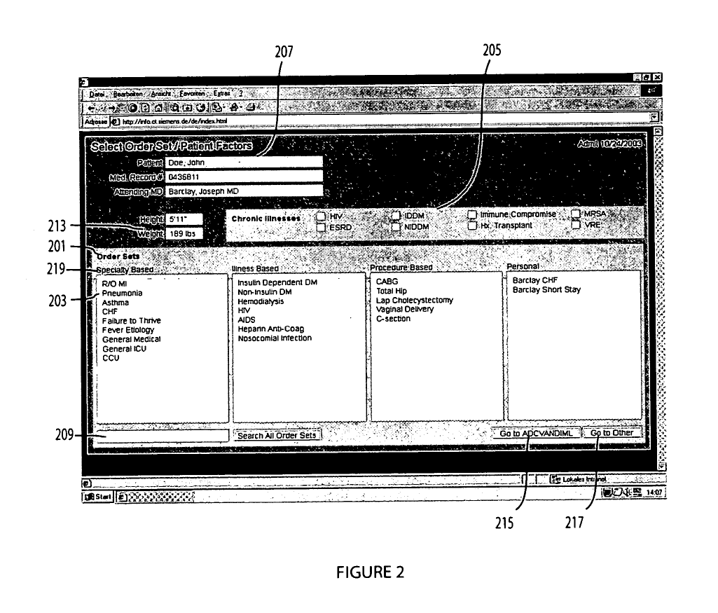

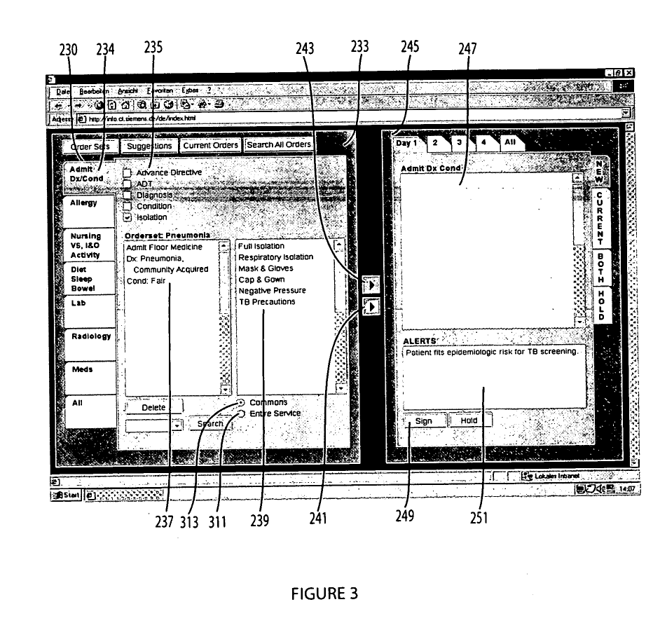

FIG. 2 shows a user interface display image menu supporting multiple mode user selection of a treatment order set for customization. The user interface image of FIG. 2 is typically used by a physician but may also be used by a nurse or other licensed clinician or trainee, through a clinical information system. A user selects an initial order set or order sets of services (including treatments), from predetermined candidate sets of services, in response to first criteria, via menu display items of FIG. 2. The predetermined candidate sets of services are categorized by, for example, at least one of, medical specialty, medical illness, medical procedure, service type and a user selected category. The first criteria comprises, for example, at least one of, patient specific criteria, a user selection, a user preference and a prediction derived automatically by a prediction processor based on patient specific criteria and historical treatment data and treatment outcome information. The patient specific criteria include one or more of, height, weight, age, a patient illness, medication prescribed for a patient, patient treatments, gender and patient preferences. A user is able to select order sets 201 from specialty associated sets, illness associated sets, procedure associated sets and customized sets (predetermined by a physician, for example) via categories indicated on row 219. The initial order set may alternatively be a list of suggested orders based on an inference process. An initial order set (such as pneumonia order set 203) is selected and subsequently customized following navigation through departmentally associated selectable order functions accessed via an image as illustrated in FIG. 3. The initial order set of services is displayed in individual images of the hierarchical sequence of departmentally associated selectable order images supporting the order functions. A departmentally associated order set image exemplified by FIG. 3 is generated in response to user selection of button 215 (FIG. 2).

An order set may be selected via the image of FIG. 2 using one of a variety of different treatment ordering strategies. An order set may be selected, for example, based on physician specialty and other considerations such as a patient's chief complaints (205), diseases, setting and patient height and weight (213) used to compute (based on inferences) expected candidate orders or treatment types. Patient height and weight (213) is also used for medication dose calculation. A user is able to navigate to menus supporting other treatment ordering strategies including user customizable ordering strategies via selection of button 217. Further, a user is able to initiate a search to identify an individual order for a service via search box 209 and to add an identified service to others to produce a combined order set. System 10 employs text entered by a user via box 209 to search for an order using text string matching or partial text string matching. A user may also scroll through candidate order lists to select a desired order.

Order processor 17 acquires, collates and stores order representative data in database 19 and is configurable to initiate a search through specific subsets of an encompassing list of orderable items (commonly known in hospital information systems as a service master). Such a service master comprises files or file directories of order representative items partitioned by department and other parameters. Order processor 17 is able to search and sort order representative data items by criteria including, department associated with an order, date, signature and workflow task sequence status (such as whether an order is signed, co-signed, verified, postponed, or re-instituted). Thereby order processor 17 is able to initiate a search through a specific subset of an encompassing order item list associated with the current hospital department order menu to which a user has navigated. Similar search functions are accessible in the other order related user interface images. Thereby a user is able to search for an individual order either by search through predetermined available orders or by a more focused search through orders associated with a specific hospital department. This focused search capability retrieves search results comprising fewer, more relevant candidate orders. This advantageously reduces the time it takes for a physician, for example, to locate orders and compose a desired order set for a particular patient.

FIG. 3 shows a second user interface display image menu supporting user selection of hospital department associated orders in addition to an initial treatment order set. A user employs display items of the FIG. 3 menu to select a service to add to the selected initial order set from a set of orderable services associated with a healthcare provider organization department, to produce a combined order set. A site administrator or user employs customization menus to configure the operational characteristics of the user interface image of FIG. 3. Such operational characteristics include, for example, the sequence of departments identified in selectable button column 230 used in department associated order selection, as well as decision support rules, alerts, or favorites lists supporting functions initiated via FIG. 3. The characteristics are fixed prior to an order selection session. The departmental order menu enables a user to combine orderable services of a previously selected initial order set (items 237 comprising a pneumonia order set) with admitting, discharge and transfer (ADT) related orders.

Ordering is typically a two-step process with both a selection and a signature step to provide the safety of an additional confirmation by a clinician. The orders that are selected are moved to the area labeled 247 and await signature from there via button 249. The system supports both order selection and order confirmation on a single screen.

The buttons of column 230 comprise tabs enabling a user to advantageously step through a series of tabbed order images individually supporting user selection of treatment orders associated with a hospital department. An individual tabbed image presents a user with treatment orders and sets of orders for selection that are associated with a particular department as well as commonly used orders associated with the particular department and individual orders derived using order search functions. The left side of the FIG. 3 image enables order selection. Specifically, a previously selected initial order set (items 237 selected via the menu of FIG. 2) are concurrently presented together with other related order representative items 239 comprising, in this example, ADT type orders. Items 239 are automatically selected from sets of services associated with a predetermined sequence of corresponding healthcare provider organization departments based on a current navigation position in the predetermined sequence of departments identified in selectable button column 230. The right side of the FIG. 3 image (incorporating window 247) provides an order viewer function enabling a user to view new, current, or held (to be executed later) orders. This function provides both ordering and navigation modes.

In a first mode, user activation of “pick and stay” button 243 moves selected order representative items (of items 237 and 239) into order viewer window 247 as selected orders to be electronically signed by a clinician. Order processor 17 (FIG. 1) automatically sorts order representative items for display in window 247 in accordance with user predetermined sort criteria. A user may select sorting alphabetically, by order type, by associated department, by sequence in which orders are administered to a patient, by critical nature of treatment, by severity of any side effects or by another user designated criteria. This first mode supports navigation among the sequenced department associated order images selectable via buttons 230 in a user determinable order. In the first mode, a user is able to sign orders, go to another department (out of the usual sequence), or exit the order function. Once these orders are electronically signed, processing is initiated to administer these items or provide these items to a designated patient.

In a second mode, user activation of “pick and go” button 241 moves selected orders (of items 237 and 239) into order viewer window 247 as selected orders to be electronically signed by clinician. However, in this second mode, activation of button 241 results in automatic image navigation from a current order image to a next order image associated with a predetermined sequence of corresponding healthcare provider organization departments. Specifically, in response to user activation of button 241, items 239 are updated to comprise orders associated with the next department in the sequence of corresponding healthcare provider organization departments identified in selectable button column 230. This second order mode supports automatic navigation from department to department (as represented by button column 230 comprising tabbed user navigable order images) in a departmental order sequence such as the “ADCVANDIML” sequence previously described.

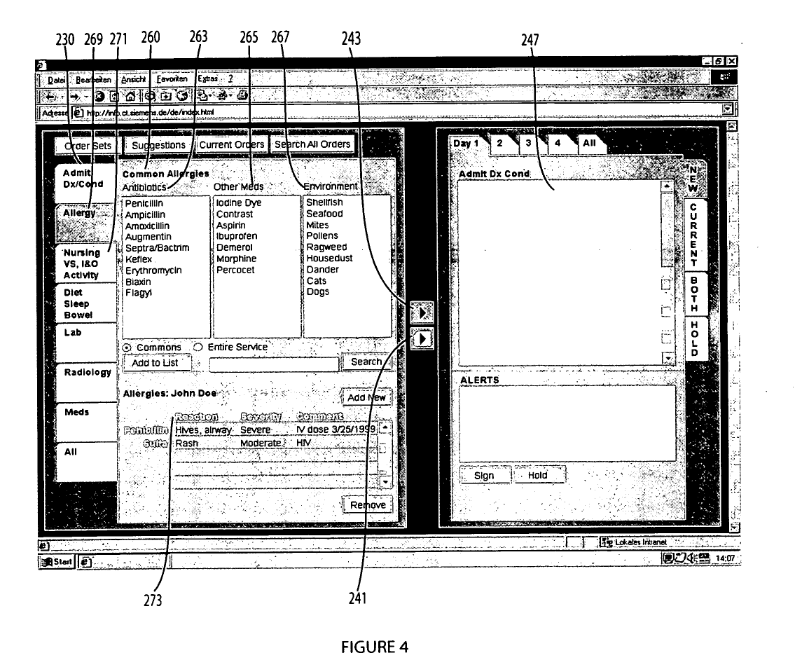

FIGS. 2-8 comprise a user menu navigation sequence that illustrates user ordering of treatments for a particular patient. As previously discussed, the user interface display image of FIG. 2 supports multiple mode clinician selection of an initial treatment order set (a pneumonia order set in this example) for customization by subsequent navigation and option selection. This image is typically accessed from a patient census list or a specific patient search screen in a hospital information system. FIG. 3 shows a second user interface display image menu (an ADT order image associated and selectable with button tab 234). The FIG. 3 image enables a clinician to create a desired order set for a particular patient by selecting from presented hospital department associated orders (ADT related orders in this example) in addition to the initial treatment order set (a pneumonia order set in this example). The clinician is able to compose the desired order set by including or omitting individual ADT (department associated) order representative items 239 or by including or omitting individual ADT order representative items contained in the initial order set and shown as items 237, for example. Further, in response to user selection of checkbox 313, items 239 represent the most commonly used orders of the subset of ADT orders (here an isolation order subset) determined by check boxes 235. Alternatively, in response to user selection of checkbox 311, items 239 represent all of the orders of the subset of ADT orders determined by check boxes 235. The clinician is also able to initiate a text search for particular orders (for inclusion in the desired order set) retained in a hospital or healthcare enterprise service master list of orderable items in database 19 (FIG. 1). Items representing the desired order set are shown in window 247 as previously described. User activation of button 241 moves selected ADT representative items (of items 237 and 239) into window 247 and results in automatic image navigation to the next order image (the allergy order image of FIG. 4).

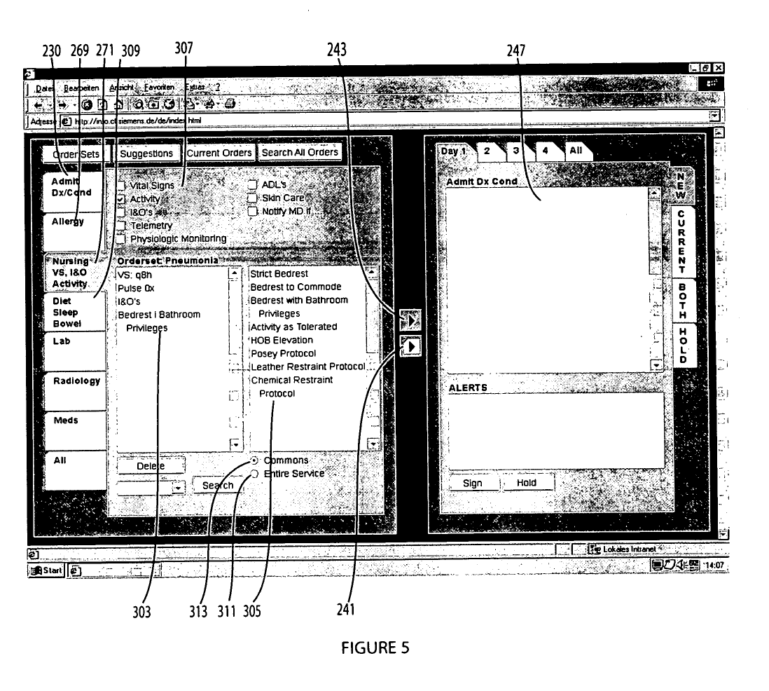

A clinician selects allergy conditions of the particular patient via the user interface allergy menu (see FIG. 4) (also selected via the FIG. 4 button tab 269 of column 230) identifying items to which the particular patient is allergic. The selected allergy conditions comprise substances (including antibiotics 263 and other medications 265) as well as environmental elements 267. In similar fashion to the image menu of FIG. 3 (and FIGS. 5-8), user activation of button 241 moves selected allergy representative items (of items 263-267) into window 247 and results in automatic image navigation to the next order image (the Nursing, VS, I&O, Activity image associated with button tab 271). User activation of button 243 moves selected allergy representative items into window 247 but does not result in automatic image navigation. Menu items 273 present a user with allergy characteristics (under headings of reaction, severity and comment) of the particular patient toward particular allergy items facilitating allergy item selection.

A clinician selects nursing department related orders for the particular patient via the user interface nursing menu (see FIG. 5) (also selected via the FIG. 5 button tab 271 of column 230). Nursing department related orders that are included in the initial (pneumonia) order set (selected via FIG. 2) are presented as elements 303 in a first window area including vital signs (“VS”) as well as inputs and outputs (“I&O's”). Other commonly used nursing orders are listed as elements 305 in a second window area. Specifically, items 305 of the second window area comprise data items representing a subset of nursing orders (identifying allowed patient activity level in this example) determined by user selection of an order subset category via check boxes 307. Items 305 show items representing an activity related subset of nursing orders available for selection because an activity checkbox of check boxes 307 is selected as shown in FIG. 5. Items 305 in the second window area are advantageously available for selection along with items 303 without requiring additional user navigation. Further, in response to user selection of checkbox 313, items 305 of the second window area represent the most commonly used orders of the subset of nursing orders determined by check boxes 307. Alternatively, in response to user selection of checkbox 311, items 305 of the second window area represent all of the orders of the subset of nursing orders determined by check boxes 307. User activation of button 241 moves selected nursing representative items (of items 303 and 305) into window 247 and results in automatic image navigation to the next order image (the Diet, Sleep and Bowel image associated with button tab 309). User activation of button 243 moves selected nursing order representative items into window 247 but does not result in automatic image navigation.

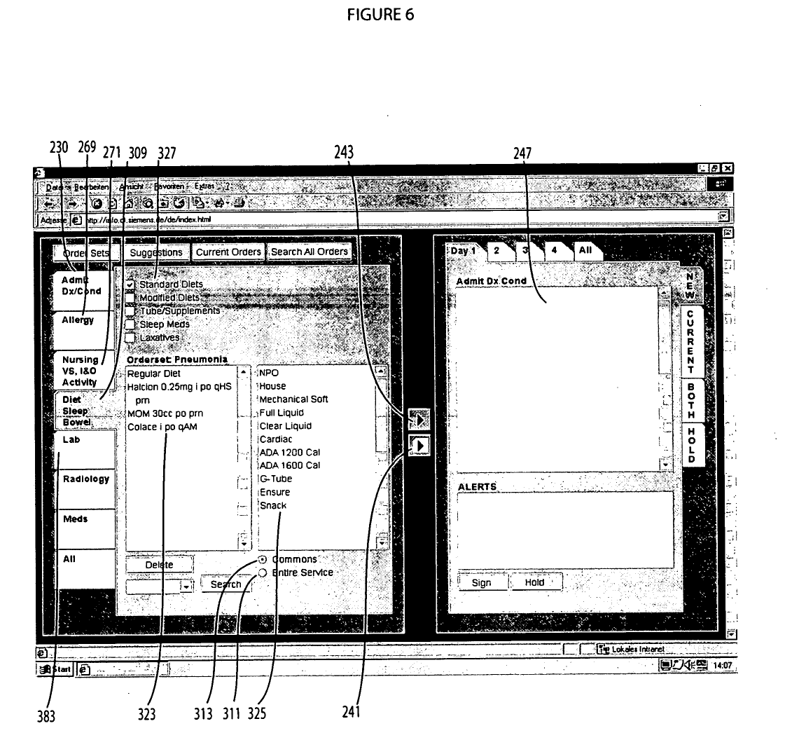

A clinician selects dietary, sleep and bowel related orders for the particular patient via the user interface dietary menu (see FIG. 6) (also selected via the FIG. 6 button tab 309 of column 230). Dietary, sleep and bowel department related orders that are included in the initial (pneumonia) order set (selected via FIG. 2) are presented as elements 323 in a first window area. Other commonly used dietary, sleep and bowel related orders are listed as elements 325 in the second window area. Specifically, items 325 of the second window area comprise data items representing a subset of dietary, sleep and bowel orders (identifying common standard diets in this example) determined by user selection of an order subset category via check boxes 327. Items 325 in the second window area are advantageously available for selection along with items 323 without requiring additional user navigation. Further, in response to user selection of checkbox 313, items 325 of the second window area represent the most commonly used orders of the subset of dietary, sleep and bowel orders determined by check boxes 327. Alternatively, in response to user selection of checkbox 311, items 325 of the second window area represent all of the orders of the subset of dietary, sleep and bowel orders determined by check boxes 327. User activation of button 241 moves selected dietary, sleep and bowel representative items (of items 323 and 325) into window 247 and results in automatic image navigation to the next order image (the laboratory image associated with button tab 383). User activation of button 243 moves selected dietary, sleep and bowel order representative items into window 247 but does not result in automatic image navigation.

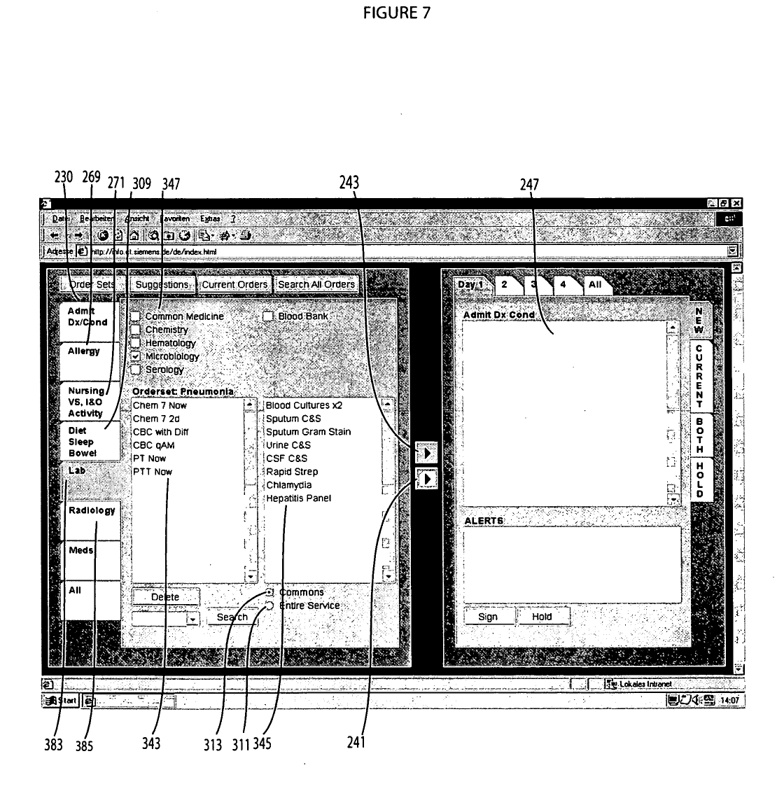

A clinician selects laboratory related orders for the particular patient via the user interface laboratory menu (see FIG. 7) (also selected via the FIG. 7 button tab 383 of column 230). Laboratory department related orders that are included in the initial (pneumonia) order set (selected via FIG. 2) are presented as elements 343 in a first window area. Other commonly used laboratory related orders are listed as elements 345 in the second window area. Specifically, items 345 of the second window area comprise data items representing a subset of laboratory orders (identifying common microbiology orders in this example) determined by user selection of an order subset category via check boxes 347. Items 345 in the second window area are advantageously available for selection along with items 343 without requiring additional user navigation. Further, in response to user selection of checkbox 313, items 345 of the second window area represent the most commonly used orders of the subset of laboratory orders determined by check boxes 347. Alternatively, in response to user selection of checkbox 311, items 345 of the second window area represent all of the orders of the subset of laboratory orders determined by check boxes 347. User activation of button 241 moves selected laboratory representative items (of items 343 and 345) into window 247 and results in automatic image navigation to the next order image (the radiology image associated with button tab 385). User activation of button 243 moves selected laboratory order representative items into window 247 but does not result in automatic image navigation.

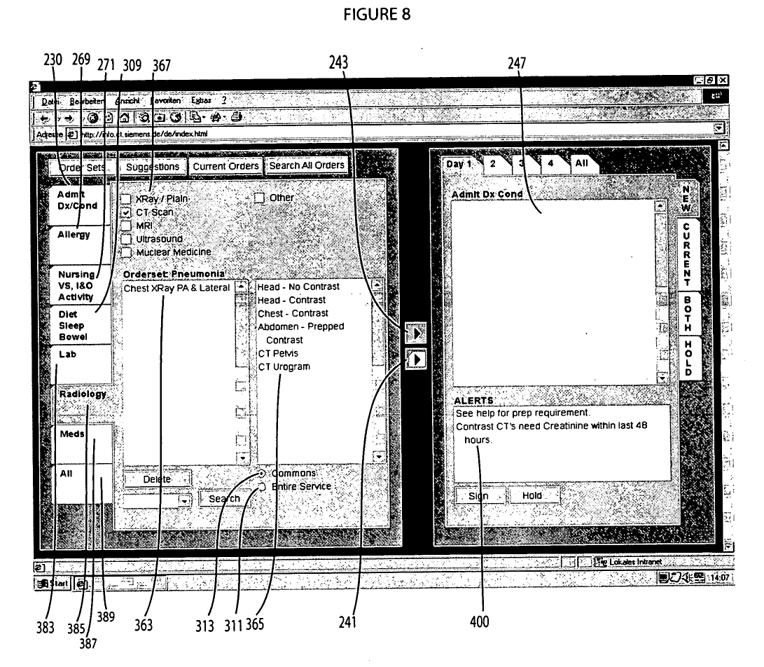

A clinician selects radiology related orders for the particular patient via the user interface radiology menu (see FIG. 8) (also selected via the FIG. 8 button tab 385 of column 230). Radiology department related orders that are included in the initial (pneumonia) order set (selected via FIG. 2) are presented as elements 363 in a first window area. Other commonly used radiology related orders are listed as elements 365 in the second window area. Specifically, items 365 of the second window area comprise data items representing a subset of radiology orders (identifying CT scan orders in this example) determined by user selection of an order subset category via check boxes 367. Items 365 in the second window area are advantageously available for selection along with items 363 without requiring additional user navigation. Further, in response to user selection of checkbox 313, items 365 of the second window area represent the most commonly used orders of the subset of radiology orders determined by check boxes 367. Alternatively, in response to user selection of checkbox 311, items 365 of the second window area represent all of the orders of the subset of radiology orders determined by check boxes 367. User activation of button 241 moves selected radiology representative items (of items 363 and 365) into window 247 and results in automatic image navigation to the next order image (the medication image associated with button tab 387). User activation of button 243 moves selected radiology order representative items into window 247 but does not result in automatic image navigation. In addition,

Order processor 17 (FIG. 1) initiates generation of clinical decision support information for presentation in alert window area 400 illustrated in the image menu of FIG. 8 (and also present in the hierarchical sequence of display image menus of FIGS. 3-7). Order processor 17 provides clinical decision support messages for display in alert window 400 using patient specific criteria. The clinical decision support information may include rules, alerts, reminders, instructions, information associated with employing the services of a combined order set selected by a user or other information associated with the particular ordering menu presented with alert window 400. The clinical decision support information may also include information identifying a medication dose, a medication interaction warning, a patient specific means to apply a treatment and patient specific care unit resources required. In the user interface radiology menu of FIG. 8, alert window 400 provides decision support notes indicating a need for an evaluation of renal function before ordering an iodine contrast CT scan, for example.

In similar fashion to the hospital department associated orders of FIGS. 3-8, a clinician also selects medication related orders for the particular patient via a user interface medication menu (also selected via the FIG. 8 button tab 387 of column 230 but not shown here). A user signs orders (using button 249 shown in FIG. 3 and the other department order images) comprising a resulting combined order set derived by user forward navigation through the hierarchical sequence of hospital department associated order images. The resulting combined order set is advantageously produced without requiring backward navigation.

A user selects button tab 389 (the “all” tab) of FIG. 8 to initiate generation of a menu providing a user with the option of merging the initial order set representative items (here from the pneumonia order set) with other order representative items the user desires. Order processor 17 (FIG. 1) creates and stores such a merged order set (or another combined order set) in database 19 as a new order set, in response to user command. This system also enables a clinician to select parts of a predetermined order set derived from database 19 without taking the whole set. A clinician using system 10 is able to select an order set and to exclude order representative items comprising laboratory tests and medications, for example. For this purpose, a clinician navigates through the departmental order sequence of column 230 accepting orders via button 241 button but does not accept orders for the laboratory test and medications menus of the order sequence. Instead, a user is able to initiate alternative ordering strategies (as previously described) whilst located at the laboratory test and medications menus

The system, processes and user interface display formats presented in FIGS. 1-8 are not exclusive. Other systems, processes and user interface forms may be derived in accordance with the principles of the invention to accomplish the same objectives. The inventive principles are applicable to providing multiple ordering strategies of other items not just healthcare related items and as such are usable in other non-healthcare related industries.

1. A system for providing a displayable list of services available for order by a healthcare provider in providing health care to a patient, comprising:
a display processor for initiating generation of data representing a single composite display image including,
a first area presenting data items representing an initial set of user selected services,
a second area presenting data items representing candidate services to add to said initial set from a set of candidate orderable services associated with a healthcare provider organization department, to produce a combined set, and
a third area presenting data items representing orders of said combined set; and
an order processor for initiating ordering of said orders in said combined set in response to user command.

2. The system of claim 1, wherein
said single composite display image includes an area enabling a user to,
initiate a search to identify an individual order for a service and
add said identified service to said combined order set.

3. The system of claim 1, including
a processor for creating and storing a new set from said combined set, in response to user command.

4. The system of claim 1, including
a processor for creating and storing a new set from a combination of said initial set and orders associated with a healthcare provider organization department, in response to user command.

5. The system of claim 1, wherein
said data items representing candidate services displayed in said second area are automatically selected from a plurality of sets of services associated with a predetermined sequence of healthcare provider organization departments based on a current navigation position in said predetermined sequence.

6. The system of claim 1, wherein
said candidate services displayed in said second area include an individual service associated with a particular healthcare provider organization department in response to user selection of a department sub-category identifier.

7. The system of claim 1, wherein
said candidate services displayed in said second area are automatically selected from a plurality of sets of services associated with a predetermined sequence of healthcare provider organization departments based on a user determined navigation position in said predetermined sequence.

8. A system for providing a displayable list of services available for order by a healthcare provider in providing health care to a patient, comprising:
a display processor for initiating generation of data representing a hierarchical sequence of display images including at least one image incorporating,
a first menu of display items enabling a user to select an initial set of services for order from predetermined candidate sets of services, in response to first criteria, and
a second menu of display items enabling a user to select a service to add to said initial order set from a set of orderable services associated with a healthcare provider organization department, to produce a combined order set; and
an order processor for initiating ordering of said orders in said combined order set in response to user command.

9. The system of claim 8, wherein
said set of orderable services associated with said healthcare provider organization department comprise a set of predetermined services associated with at least one of, (a) admission, discharge or transfer, (b) allergies, (c) nursing, (d) diet, (e) sleep, (f) laboratory testing, (g) radiology and (h) medication.

10. The system of claim 9, wherein
said set of orderable services associated with said healthcare provider organization department is selected from a plurality of sets of orders associated with a particular healthcare provider organization department in response to user selection of a department sub-category identifier.

11. The system of claim 9, wherein
said set of orderable services comprises an order for an individual service associated with a particular healthcare provider organization department in response to user selection of a department sub-category identifier.

12. The system of claim 8, wherein
said second menu of display items includes a plurality of user selectable buttons associated with a corresponding plurality of healthcare provider organization departments and
said set of orderable services associated with said healthcare provider organization department is displayed in response to user selection of a button associated with said healthcare provider organization department.

13. The system of claim 12, wherein
said plurality of user selectable buttons corresponding to said plurality of healthcare provider organization departments are sequentially arranged in said second menu in a predetermined sequence.

14. The system of claim 8, wherein
said hierarchical sequence of display images comprises a user navigable hierarchical sequence of display images including a first area in a first image for displaying said initial set of services and said added service and
selected services of said initial set of services and said added service are transferred to a second area in said first image in response to a second user command.

15. The system of claim 14, wherein
in response to said second user command,
a set of orderable services associated with a healthcare provider organization department is automatically displayed in said second menu.

16. The system of claim 15, wherein
said set of orderable services automatically displayed in said second menu is automatically selected from a plurality of sets of services associated with a predetermined sequence of healthcare provider organization departments based on a current navigation position in said predetermined sequence.

17. The system of claim 8, wherein
said display processor initiates generation of data representing a single composite display image including,
a first area presenting said initial set of services selected based on said first criteria, and
a second area presenting said service to add to said initial order set from a set orderable services associated with a healthcare provider organization department, to produce said combined order set.

18. The system of claim 8, wherein
said hierarchical sequence of display images includes,
image elements enabling a user to add and delete individual services from said initial set of services, and from said set of orderable services associated with said healthcare provider organization department, to produce said combined order set.

19. The system of claim 8, wherein
said hierarchical sequence of display images includes,
an image element enabling a user to add and delete a collection of individual services associated with a particular department from said combined order set.

20. The system of claim 8, wherein
said hierarchical sequence of display images includes,
image elements enabling a user to select for display at least one of, (a) all orders for services and (b) common orders excluding less commonly ordered services, in at least one of said first menu and said second menu.

21. The system of claim 8, wherein
said first menu presents predetermined candidate sets of services, categorized by at least one of, (a) medical specialty, (b) medical illness, (c) medical procedure, (d) service type and (e) a user selected category.

22. The system of claim 8, wherein
said first criteria comprise at least one of, (a) patient specific criteria, (b) a user selection, (c) a user preference and (d) a prediction derived automatically by a prediction processor based on patient specific criteria and historical treatment data and treatment outcome information.

23. The system of claim 8, wherein
said hierarchical sequence of display images comprises a user navigable hierarchical sequence of display images including an area in an image for displaying a message to a user in response to selection of said produced combined order set, said message comprising at least one of, (a) an alert, (b) a rule, (c) an instruction, (d) a reminder and (e) information, associated with employing said services of said combined order set.

24. The system of claim 23, including
a message processor for using patient specific criteria in determining information to be provided in said message, said information comprising at least one of, (a) a medication dose, (b) a medication interaction warning, (c) a patient specific means to apply a treatment and (d) patient specific care unit resources required.

25. The system of claim 8, including
said first criteria comprise patient specific criteria including at least one of, (a) height, (b) weight, (c) age, (d) a patient illness, (e) medication prescribed for a patient, (f) patient treatments, (g) gender and (h) patient preferences.

26. The system of claim 8, wherein
said hierarchical sequence of display images includes an area in an image enabling a user to,
initiate a search to identify an individual order for a service and
add said identified service to said combined order set.

27. The system of claim 26, wherein
said area in said image supports user entry of a text string to search by at least one of, (a) text string matching and (b) partial text string matching.

28. The system of claim 26, wherein
said area in said image comprises a scrollable list of at least one of, (a) candidate individual services and (b) candidate order sets, and said user initiates said search by navigating through said scrollable list.

29. The system of claim 8, wherein
said hierarchical sequence of display images enables a user to identify and select an allergy specific to said patient.

30. The system of claim 8, wherein
said services comprise at least one of, (a) services performed by a healthcare worker for a patient, (b) goods to be used in providing a service to a patient, (c) medication to be administered to a patient, (d) treatment to be provided to a patient and (e) therapy to be provided to a patient.

31. The system of claim 8, wherein
said initial set of services is displayed in all of said hierarchical sequence of images and
said combined order set is produced by user navigation through said hierarchical sequence of images without requiring backward navigation.

32. A system for providing a displayable list of services available for order by a healthcare provider in providing health care to a patient, comprising:
a display processor for initiating generation of data representing a hierarchical sequence of display images including,
a first menu including image elements enabling a user to at least one of,
(a) select an initial set of services from predetermined candidate sets of services for inclusion in a set for order, in response to first criteria and
(b) initiate generation of a second menu of display items enabling a user to select a service from a set of orderable services associated with a healthcare provider organization department, for inclusion in said set for order; and
an order processor for initiating ordering of said set for order in response to user command.

33. In a user interface system supporting a process including a sequence of tasks, a method comprising the activities of:
initiating display of a user navigable hierarchical sequence of images including,
display items enabling a user to select an initial set of services for order from predetermined candidate sets of services, in response to user selected first criteria, and
a plurality of user selectable buttons associated with a corresponding plurality of healthcare provider organization departments enabling a user to select a service to add to said initial order set from a set of orderable services associated with a particular healthcare provider organization department, to produce a combined order set; and
an order processor for initiating ordering of said orders in said combined order set in response to user command

34. A method of claim 33, wherein
in response to adding said service selected from said set of orderable services associated with said particular healthcare provider organization department to said initial order set,
automatically displaying an order set associated with a second healthcare provider organization department, said second healthcare provider organization department being sequentially determined based on a predetermined ordering task sequence.

35. A method for providing a displayable list of services available for order by a healthcare provider in providing health care to a patient, comprising the activities of:
initiating generation of data representing a user navigable hierarchical sequence of images including,
a first menu of display items enabling a user to select an initial set of services for order from predetermined candidate sets of services, and
a second menu of display items enabling a user to select a service to add to said initial order set from a set of orderable services associated with a healthcare provider organization department, to produce a combined order set; and
initiating ordering of said orders in said combined order set in response to user command.

36. A method for providing a displayable list of services available for order by a healthcare provider in providing health care to a patient, comprising the activities of:
initiating generation of data representing a single composite display image including,
a first area presenting data items representing an initial set of services selected based on first criteria,
a second area presenting data items representing candidate services to add to said initial set from a set of candidate orderable services associated with a healthcare provider organization department, to produce a combined set, and
a third area presenting data items representing orders of said combined set; and
initiating ordering of said orders in said combined set in response to user command.

37. A method according to claim 36, wherein
said single composite display image includes an area enabling a user to initiate a search to identify an individual order for a service.
